(19) United States
(12) Patent Application Publication
(10) Pub. No.: US 2012/0245919 A1
(43) Pub. Date: Sep. 27, 2012

(54) Probabilistic Representation of Acoustic Segments

(75) Inventors: Guillermo Aradilla, Nantes (FR); Rainer Gruhn, Ulm (DE)

(73) Assignee: NUANCE COMMUNICATIONS, INC., Burlington, MA (US)

(21) Appl. No.: 13/497,138

(22) PCT Filed: Sep. 23, 2009
(86) PCT No.: PCT/US09/57974

§ 371 Date: Jun. 1, 2012

(51) Int. Cl. G10L 15/02; G06F 17/28

(52) U.S. Cl. 704/2; 704/E15.004

(57) ABSTRACT

An automatic speech recognition (ASR) apparatus for an embedded device application is described. A speech decoder receives an input sequence of speech feature vectors in a first language and outputs an acoustic segment lattice representing a probabilistic combination of basic linguistic units in a second language. A vocabulary matching module compares the acoustic segment lattice to vocabulary models in the first language to determine an output set of probability-ranked recognition hypotheses. A detailed matching module compares the set of probability-ranked recognition hypotheses to detailed match models in the first language to determine a recognition output representing a vocabulary word most likely to correspond to the input sequence of speech feature vectors.

### FIELD OF THE INVENTION

The present invention relates to speech recognition, specifically, to acoustic representations of speech for speech recognition.

### BACKGROUND ART

Embedded devices such as PDAs and cell phones often provide automatic speech recognition (ASR) capabilities. The complexity of the ASR tasks is directly related to the amount of data that theses devices can handle, which continues to increase. Typical applications can be for locating a given address on a map or searching for a particular song in a large music library. In those cases, the vocabulary size can range in the order of hundreds of thousands of words. Given the limited device resources and constraints in the computational time, special care must be taken in the design of ASR systems for embedded devices.

FIG. 1 shows various functional blocks in a typical embedded AST system, where the general structure is divided into two major parts: fast matching and detailed matching; see, e.g., Chung et al., Fast Speech Recognition to Access a Very Large List of Items on Embedded Devices, IEEE Transactions on Consumer Electronics, vol. 54, pp, 803-807, 2008; incorporated herein by reference. Fast matching attempts to reduce the list of possible hypotheses by selecting a set of likely entries from the system vocabulary. Fast matching consists of two main steps. First, the input acoustic signal is decoded into a sequence of acoustic segments, which are traditionally represented by linguistic units such as phonemes. Second, this acoustic segment sequence is compared to each phonetic transcription from the system vocabulary yielding a score which represents its similarity matching. The most similar words are then selected as possible hypotheses. So the main goal of the fast match is to obtain a high similarity between the sequence of acoustic segments and the phonetic transcription of the correct word. Detailed matching estimates a more precise likelihood between the acoustic signal and the selected hypotheses. Detailed matching is computationally expensive because of the precise likelihood estimation, so fast matching provides a hypothesis list which is as short as possible while keeping the correct word. In some applications, the part corresponding to the detailed matching is skipped and a short list of hypotheses is presented to the user (a pickup list).

### SUMMARY OF THE INVENTION

Embodiments of the present invention are directed to an automatic speech recognition (ASR) apparatus for an embedded device application. A speech decoder receives an input sequence of speech feature vectors in a first language and outputs an acoustic segment lattice representing a probabilistic combination of basic linguistic units (e.g., phonemes or sub-phonemes) in a second language. A vocabulary matching module compares the acoustic segment lattice to vocabulary models in the first language to determine an output set of probability-ranked recognition hypotheses. A detailed matching module compares the set of probability-ranked recognition hypotheses to detailed match models in the first language to determine a recognition output representing a vocabulary word most likely to correspond to the input sequence of speech feature vectors.

In some specific embodiments the detailed matching module may use discrete hidden Markov models. The speech decoder may be a neural network decoder such as a multi-layer perceptron. Or the speech decoder may use Gaussian mixture models. The embedded device application may be a spell matching application.

### BRIEF DESCRIPTION OF THE DRAWINGS

FIG. 1 shows various functional blocks in a typical embedded ASR system for which embodiments of the present invention are intended.

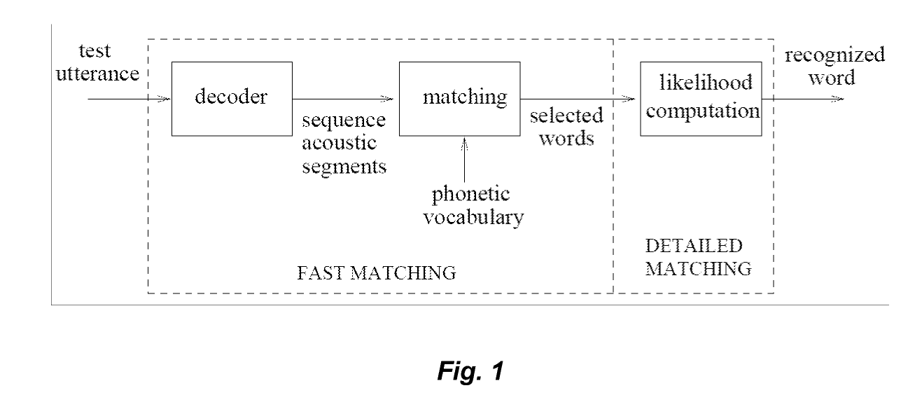

### DETAILED DESCRIPTION OF SPECIFIC EMBODIMENTS

Standard speech recognition systems for embedded systems rely on a phonetic decoder for describing the test utterance. Accordingly, the test utterance is typically characterized as a sequence of phonetic or sub-phonetic classes. By allowing that only one phoneme describes an acoustic segment, the representation is over-simplified and potentially relevant information is lost.

The typical embedded ASR approach closely parallels with models of human speech recognition (HSR). Studies on HSR assert that human listeners map the input acoustic signal into a intermediate (pre-lexical) representation, which is then mapped into a word-based (lexical) representation. Further studies on HSR suggest that given the uncertainty for defining an appropriate set of pre-lexical units, these units should be probabilistic.

In embodiments of the present invention, the sequence of acoustic segments obtained from the decoder are treated as a mapping between the input signal and a set of pre-lexical units, while the matching step maps these pre-lexical units with a lexical representation based on phonetic transcriptions from a recognition vocabulary. Each acoustic segment is described as a probabilistic combination of single linguistic units. This provides a finer characterization of the acoustics of the test utterance than the standard approach which employs single (deterministic) linguistic units. Representing each acoustic segment as a probabilistic combination of linguistic units provides a more general description of each segment, thereby improving system performance. Embodiments of the present invention also can be used when the linguistic units from the decoder do not correspond to the linguistic units of the phonetic transcription from the system vocabulary. This situation typically applies in multi-lingual scenarios.

### Decoder

The two main components of the fast matching step are the decoder and the matcher. A sequence of standard speech features vectors (e.g., perceptual linear prediction (PLP) or mel-frequency cepstral coefficients (MFCCs)) is initially extracted from an input acoustic signal. This sequence of features is then used as input to a unconstrained decoder based on hidden Markov models (HMMs). The emission probability of HMM states can be estimated from a mixture of Gaussians (GMMs) or a multi-layer perceptron (MLP). The possible outputs from the decoder are a set of N linguistic units U={uᵢ}ᵢ₌₁^{N}. Since the set U is relatively small (in the order of one hundred units), this decoding step is relatively simple and fast. In the standard approach, the set of linguistic units corresponds to the set of phonemes.

A decoder may be based on hybrid HMM/MLP which outperforms HMM/GMM when decoding single events such as in this case where unconstrained linguistic units are decoded. Given a sequence of T feature vectors X={x₁, . . . , xₜ, . . . , x_{T}}, a sequence of posterior vectors Z={z₁, . . . , zₜ, . . . , z_{T}} of the same length can be estimated from a MLP. Each posterior vector defines a probability distribution over the space of linguistic units zₜ=[p(u_{l|}|xₜ), . . . , p(u_{N|}|xₜ)]^{T}. Scaled state emission likelihoods can then be estimated from these posteriors using the Bayes' rule. A Viterbi-based decoder is then applied to the scaled likelihoods to obtain the sequence of decoded units. If the time boundaries are also obtained, the output of the decoder can be seen as a segmentation of the input acoustic signal. A sequence of M segments S={sₗ, . . . , sᵢ, . . . , s_{M}} is then obtained from the decoder, where each segment sᵢ corresponds to a linguistic unit sᵢεU.

### Matcher

In the matching phase, a matcher based on a discrete HMM yields a score representing the similarity between the sequence S and each phonetic transcription. This matcher is hence characterized by a set of states and a set of observations. (NB: Transition probabilities are assumed to be uniform since they do not significantly affect the final result.) The set of states corresponds to the set of V different phonemes C={cᵢ}ᵢ₌₁^{V} appearing in the phonetics of the vocabulary. The set of observations corresponds to the set of linguistic units U. The state representing the phoneme c is then characterized by a discrete emission distribution over the space of linguistic units {p(uⱼ|cᵢ)}ⱼ₌₁^{N}.

Given a sequence of acoustic segments S and a phonetic transcription L={ĉₗ, . . . , ĉ_{Q}} of Q phonemes, the similarity score φ(S, L) is defined as:

$$φ ( S , L ) = - {\sum }_{i = 1}^{M} log p ( {s}_{i} \vert {\hat{c}}_{ρ ( i )} ) \qquad Eq . ( 1 )$$

where p refers to the Viterbi path between S and L. (NB: Deletion errors are ignored for clarity). A more complete description of a matching algorithm can be found in E. S. Ristad and P. N. Yianilos, Learning String Edit Distance, IEEE Transactions of Pattern Analysis and Machine Learning, vol 20, pp. 522-532, 1998; incorporated herein by reference.

### Probabilistic Output

Embodiments of the present invention provide a multiple probabilistic representation of each acoustic segment generated by the decoder. As seen above, the decoder in the standard approach outputs a sequence of segments where each segment sᵢ represents a single linguistic unit sᵢεU. Given the uncertainty for defining an optimal linguistic unit, each segment can be represented as a set of multiple linguistic units where each one is characterized by a probability. Thus, the output of the decoder can be seen as a probabilistic lattice.

The nodes in the lattice can be determined by the most likely path, so a Viterbi decoder can be applied to obtain the time boundaries of the segments. Then, for each segment sᵢ, a probabilistic score pᵢ^{j} is computed for each linguistic unit uⱼ. If bᵢ and eᵢ denote the beginning and ending frames of segment sᵢ, the score pᵢ^{j} can be estimated as:

$${p}_{i}^{j} = \frac{1}{{e}_{i} - {b}_{i} + 1} {\sum }_{t = {b}_{i}}^{{e}_{i}} p ( {u}_{j} \vert {x}_{t} ) \qquad Eq . ( 2 )$$

where the posteriors p(uⱼ|xₜ) are obtained from the posterior frames zₜ generated by the MLP. This expression estimates the expected probability of the acoustic unit uⱼ within the segment sᵢ.

### Matcher

The expression in Eq. (1) defines a matching score between a sequence of acoustic segments S and a sequence of phonemes L. In that case, the segments are described by a single linguistic units—i.e. they are deterministic. Embodiments of the present invention use a probabilistic representation of each segment composed by multiple weighted linguistic units. Hence, the algorithm for computing the matching score φ(S, L) is redefined. One approach is to search through the probabilistic lattice for the best path as implemented in Scharenborg et al., Should A Speech Recognizer Work? Cognitive Science, vol. 29, pp. 867-918, 2005; incorporated herein by reference. However, this way requires a large number of computations and pruning techniques must typically be applied to make the process practical.

A usable matching algorithm has been previously used in other applications where discrete HMMs have used multiple inputs. In particular, it was first proposed in E, Tsuboka and J. Nakahashi, On the Fuzzy Vector Quantization Based Hidden Markov Model, IEEE Transactions on Speech and Audio Processing, vol. 1, pp. 637-6640, 1994 (incorporated herein by reference) in the context of fuzzy logic. More recently, the same expression has been derived as a generalization of discrete HMM (see, G. Aradilla, H. Bourlard, and M. M. Doss, Using KL-Based Acoustic Models in a Large Vocabulary Recognition Task, Proceedings of ICSLP, 2008; incorporated herein by reference) where the emission probabilities are interpreted as the Kullback-Leibler divergence between the probability distribution characterizing the HMM state and an input probability distribution. The modified matching score can be expressed as:

$$φ ( S , L ) = - {\sum }_{i = 1}^{M} {\sum }_{j = 1}^{N} {p}_{i}^{j} log p ( {u}_{j} \vert {\hat{c}}_{ρ ( i )} ) \qquad Eq . ( 3 )$$

An advantage of this formulation is that it does not significantly increase the computational time since it only affects the computation of the emission likelihood. Hence, once the state emission likelihoods

$${\sum }_{j = 1}^{N} {p}_{i}^{j} log p ( {u}_{j} \vert {c}_{k} )$$

are computed for all the segments 1≦i≦M and for all the phonemes 1≦k≦V, the standard Viterbi decoding algorithm can be performed in the same way as if using single input labels. It can also be noted that the standard approach is a particular case of this probabilistic representation, where the linguistic unit with the highest probability within each segment is given a probability one and the rest are assigned a null probability.

### Sub-Phonetic Representation

The standard approach use the set of phonemes as linguistic units, C=U. In this way, the matcher maps sequences of phonemes from the decoder with sequences of phonemes from the phonetic transcriptions of the vocabulary. However, nothing prevents using some other type of linguistic units such as the use of sub-phonetic classes as linguistic units. Each sub-phonetic class can be obtained by uniformly splitting each phoneme into three parts. In this way, each sub-phonetic class can better capture the acoustic variability within a phoneme. These classes are equivalent to the state representations in standard HMM/GMMs for ASR, where each basic acoustic model contains three states. In addition, the use of MLP-based posterior probabilities of these sub-phonetic classes has shown significant improvement in phoneme recognition tasks.

### Task-Independent Linguistic Units

As seen with the use of sub-phonetic units representing acoustic segments, the matching discrete HMM can map different acoustic sets. This suggests the possibility to use linguistic units that are not related to the recognition task. In particular, applications can use the set of phonemes and sub-phonemes of a different language than the one used for the test set, and the linguistic units obtained from the decoder can be considered as task-independent. When using a probabilistic representation in this case, the actual acoustic unit from the test utterance can be represented as a weighted combination of the task-independent linguistic units. This allows the test utterance to be described in a more precise way.

### Experiments

Experiments have been carried out on an English database containing streets in California. The test data was formed by 8K utterances with a system vocabulary of 190K different entries. Standard MFCC features with cepstral mean normalization were extracted from the acoustic signal, with each MFCC feature vector containing 11 dimensions. An MLP was trained on an English database using 35K utterances containing locations. A context of 9 MFCC features was used as input for the MLP—i.e., there were 9×11=99 input nodes. The hidden layer contained 1000 units and there were 49 outputs corresponding to the total number of English phonemes. Posteriors of sub-phoneme classes were also estimated using a MLP following the same structure, where the number of outputs was 49×3=147. The cross-validation set corresponded to 5K utterances.

Experiments using task-independent linguistic units were also carried out using German phonemes. An MLP trained on a German database was used with training data of a similar size as the English one, 35K utterances containing German locations. The number of input and hidden nodes was the same as the MLP estimating English units, but the number of outputs was different because the number of German phonemes is higher (55), so the MLP contained 55 outputs when estimating posteriors of phonemes, and 55×3=165 outputs when estimating sub-phoneme posteriors. The discrete HMM mapping the acoustic units to the phonetic transcriptions was trained on the same training data as used for the English database following the Baum-Welch procedure for HMMs.

The experiments were evaluated by the list accuracy within the top-n most likely hypotheses. The list accuracy was defined as the percentage of test utterances whose phonetic transcriptions obtained a matching score within the n lowest ones. Results were obtained on list sizes of 1, 5 and 10 hypotheses, which correspond to typical sizes of pickup lists.

Table 1 shows the results when using the deterministic and the probabilistic representation of both phonetic and sub-phonetic units when English units were used as output of the decoder.

TABLE 1
System evaluation using English units. The list accuracy
expressed in percentage for different list sizes is presented.

| | top-1 | top-5 | top-10 |
|---|---|---|---|
| MLP | 43.6 | 62.2 | 68.3 |
| MLP sub | 43.3 | 62.1 | 68.2 |
| MLP-prob | 49.6 | 67.2 | 73.4 |
| MLP sub-prob | 51.6 | 72.1 | 77.8 |

The first and the second row correspond to the deterministic representation using phonemes and sub-phonemes respectively. It can be observed that the system accuracy was similar in both situations, suggesting that the use of sub-phonetic units does not provide a richer description of the acoustic space of the test utterances. The third and fourth row correspond to the experiments using a probabilistic representation. It can be seen that expressing each acoustic segment from the decoder in a probabilistic form can significantly increase the performance of the system. Results using a probabilistic representation and a list size of 5 hypotheses are similar or better than the results obtained using a deterministic representation and a list size of 10 hypotheses. Hence, using a probabilistic representation can reduce the list size in half and still obtain better accuracy.

Table 2 shows the results when German units are obtained from the decoder using the deterministic and the probabilistic representation of both phonetic and sub-phonetic units. Since the test set used English transcriptions, the discrete HMM mapped German units to the English phonemes describing the phonetic transcriptions.

TABLE 2
System evaluation using English units. The list accuracy
expressed in percentage for different list sizes is presented.

| | top-1 | top-5 | top-10 |
|---|---|---|---|
| MLP | 28.0 | 45.2 | 53.2 |
| MLP sub | 33.5 | 52.1 | 59.5 |
| MLP-prob | 38.8 | 59.1 | 65.6 |
| MLP sub-prob | 45.0 | 65.9 | 72.3 |

Unlike the English experiment where sub-phonetic units did not improve the performance of the system when using a deterministic representation, in this case, the use of sub-phonemes clearly yielded a better performance. This can be explained because the linguistic units of the test utterances were different from the units provided by the decoder. The actual linguistic units from the test utterance (English phonemes) could be mapped onto a larger set of linguistic units (German sub-phonemes) and hence, obtain a better characterization. As in the previous experiments, the use of a probabilistic representation further increased system performance. The accuracy improvement, in this case, was higher than in the previous experiment, suggesting that the probabilistic representation can be more beneficial when there is a mismatch between the decoded linguistic units and the linguistic units used to represent the phonetic transcriptions of the system vocabulary. This can be explained because the probabilistic representation can be seen as a projection onto a set of basic linguistic units. Hence, the actual acoustic segments from the test utterance can be represented as a weighted combination of units.

### Computational Issues

When dealing with ASR for embedded systems, the computational requirements of the process are an important issue. The most computationally expensive step within the fast matching part corresponds to the computation of the similarity score between the test utterance and each phonetic transcription of the system vocabulary. Embodiments of the present invention use a probabilistic representation that obviously modifies that algorithm for computing this similarity score. As explained above, the advantage of the expression used in this work is that it does not significantly increase the computational time because the emission probabilities can be computed before the phonetic transcriptions are actually evaluated. On the other hand, the use of sub-phonetic classes also increases the computational time of the decoder. In particular, the computational time is roughly proportional to the number of linguistic units. Hence, this time in this case is multiplied by three. However, since the number of linguistic units is relatively small, the computational time of this step is quite short and, when compared to the computation of the matching score, is not significant. In a similar way, the estimation of the segment probabilities does not represent a significant increase of the total time.

Embodiments of the invention may be implemented in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. An automatic speech recognition (ASR) apparatus for an embedded device application, the apparatus comprising:
a speech decoder for receiving an input sequence of speech feature vectors in a first language and outputting an acoustic segment lattice representing a probabilistic combination of basic linguistic units in a second language.

2. An ASR apparatus according to claim 1, wherein the basic linguistic units are phonemes in the second language.

3. An ASR apparatus according to claim 1, wherein the basic linguistic units are sub-phoneme units in the second language.

4. An ASR apparatus according to claim 1, further comprising:
a vocabulary matching module for comparing the acoustic segment lattice to vocabulary models in the first language to determine an output set of probability-ranked recognition hypotheses.

5. An ASR apparatus according to claim 1, further comprising:
a detailed matching module for comparing the set of probability-ranked recognition hypotheses to detailed match models in the first language to determine a recognition output representing a vocabulary word most likely to correspond to the input sequence of speech feature vectors.

6. An ASR apparatus according to claim 5, wherein the detailed matching module uses discrete hidden Markov models.

7. An ASR apparatus according to claim 1, wherein the speech decoder is a neural network decoder.

8. An ASR apparatus according to claim 7, wherein the neural network is organized as a multi-layer perceptron.

9. An ASR apparatus according to claim 1, wherein the speech decoder uses Gaussian mixture models.

10. An ASR apparatus according to claim 1, wherein the embedded device application is a spell matching application.

11. A method for automatic speech recognition (ASR) apparatus in an embedded device application, the method comprising:
receiving an input sequence of speech feature vectors in a first language; and
outputting an acoustic segment lattice representing a probabilistic combination of basic linguistic units in a second language.

12. A method according to claim 11, wherein the basic linguistic units are phonemes in the second language.

13. A method according to claim 11, wherein the basic linguistic units are sub-phoneme units in the second language.

14. A method according to claim 11, further comprising:
comparing the acoustic segment lattice to vocabulary models in the first language to determine an output set of probability-ranked recognition hypotheses.

15. A method according to claim 11, further comprising:
comparing the set of probability-ranked recognition hypotheses to detailed match models in the first language to determine a recognition output representing a vocabulary word most likely to correspond to the input sequence of speech feature vectors.

16. A method according to claim 15, wherein discrete hidden Markov models are used to determine the recognition output.

17. A method according to claim 11, wherein a neural network is used for outputting the acoustic segment lattice.

18. A method according to claim 17, wherein the neural network is organized as a multi-layer perceptron.

19. A method according to claim 11, wherein Gaussian mixture models are used for outputting the acoustic segment lattice.

20. A method according to claim 11, wherein the embedded device application is a spell matching application.

21. An automatic speech recognition (ASR) apparatus for an embedded device application, the apparatus comprising:
means for receiving an input sequence of speech feature vectors in a first language; and
means for outputting an acoustic segment lattice representing a probabilistic combination of basic linguistic units in a second language.

22. An ASR apparatus according to claim 21, wherein the basic linguistic units are phonemes in the second language.

23. An ASR apparatus according to claim 21, wherein the basic linguistic units are sub-phoneme units in the second language.

24. An ASR apparatus according to claim 21, further comprising:
means for comparing the acoustic segment lattice to vocabulary models in the first language to determine an output set of probability-ranked recognition hypotheses.

25. An ASR apparatus according to claim 21, further comprising:
means for comparing the set of probability-ranked recognition hypotheses to detailed match models in the first language to determine a recognition output
representing a vocabulary word most likely to correspond to the input sequence of speech feature vectors.

26. An ASR apparatus according to claim 25, wherein the means for comparing uses discrete hidden Markov models.

27. An ASR apparatus according to claim 21, wherein the means for outputting uses a neural network for outputting the acoustic segment lattice.

28. An ASR apparatus according to claim 27, wherein the neural network is organized as a multi-layer perceptron.

29. An ASR apparatus according to claim 21, wherein the means for outputting uses Gaussian mixture models for outputting the acoustic segment lattice.

30. An ASR apparatus according to claim 21, wherein the embedded device application is a spell matching application.
